(19) United States
(12) Patent Application Publication
(10) Pub. No.: US 2006/0219075 A1
(43) Pub. Date: Oct. 5, 2006

(54) Apparatus for adjusting position of saw blade of table saw

(75) Inventors: Chia-Sheng Liu, Chiayi County (TW); Chieh-Yuan Tsai, Taichung County (TW)

Correspondence Address: BACON & THOMAS, PLLC, 625 SLATERS LANE, FOURTH FLOOR, ALEXANDRIA, VA, 22314, US

(73) Assignee: DURQ MACHINERY CORP., TAICHUNG (TW)

(21) Appl. No.: 11/152,223

(22) Filed: Jun. 15, 2005

(30) Foreign Application Priority Data
Apr. 1, 2005 (TW) 94205142

(51) Int. Cl. B23D 45/06

(52) U.S. Cl. 83/471.3; 83/477.2

(57) ABSTRACT

A saw blade adjustment structure used in a table saw for correcting the position of a saw blade of a saw unit includes a supporting member provided below the bottom side of the table of the table saw to support the saw unit of the table saw, and an adjustment device, which includes a driven member connected to the supporting member and a rotating member that has an eccentric portion for moving the driven member to correct the position of the saw blade upon rotation of the rotating member by an external rotary driving force.

### BACKGROUND OF THE INVENTION

1. Field of the Invention

The present invention relates to a table saw and more particularly, to a position-adjusting apparatus for a saw blade of a table saw.

2. Description of the Related Art

Referring to FIG. 1, a conventional table saw 1 comprises a table 2 and a saw unit 3. The table 2 has an elongated slot 2a. The saw unit 3 is fastened to a support bar 4, which is locked to the bottom side of the table 2. The saw unit 3 comprises a saw blade 3a suspending in the elongated slot 2a. The cutting direction of the saw blade 3a is kept perpendicular to the front edge 2b of the table 2 for cutting the workpiece conveniently.

However, the saw blade 3a may be deviated from the position and not kept perpendicular to the front edge 2b of the table 2 due to impact of an external object accidentally during delivery of the table saw 1, inaccurate installation, or other unexpected reasons. For example, the imaginary line in FIG. 1 shows a deviated status of the saw blade 3a. This position deviation will cause an error in size of the cut workpiece.

Therefore, it is desirable to provide a table saw that eliminates the aforesaid problem.

### SUMMARY OF THE INVENTION

The present invention has been accomplished under the circumstances in view. It is one object of the present invention to provide a saw blade adjustment structure for table saw, which enables the user to adjust the position of the saw blade conveniently.

To achieve this object of the present invention, the saw blade adjustment structure is used in a table saw having a table, an elongated opening formed in the table, and a saw unit installed in the bottom side of the table. The saw unit has a saw blade suspending in the elongated opening for cutting. The saw blade adjustment structure comprises a supporting structure, and at least one adjustment device. The supporting structure comprises a supporting member provided below the bottom side of the table. The supporting member has at least one connection portion and defines a first axis. The at least one adjustment device is set between the table and the supporting structure. Each adjustment device comprises a driven member coupled to one of the at least one connection portion of the supporting member and movable along a second axis that is not in parallel to the first axis, and a rotating member. The rotating member has an eccentric portion for moving the driven member along the second axis upon rotation of the rotating member by an external rotary driving force.

### BRIEF DESCRIPTION OF THE DRAWINGS

FIG. 1 is a schematic top view of a part of a table saw according to the prior art.

FIG. 2 is an exploded view of a saw blade adjustment structure for table saw according to a preferred embodiment of the present invention.

FIG. 3 is a schematic bottom view of the present invention.

FIG. 4 is a schematic top view in section of a part of the preferred embodiment of the present invention.

FIG. 5 is a sectional view taken along line 5-5 of FIG. 4.

FIG. 6 is a top view of a part of the present invention before rotation of the rotating member.

FIG. 7 is a side view in section of FIG. 6.

FIG. 8 is a perspective view of the rotating member according to the present invention.

FIG. 9 is a sectional view of the rotating member according to the present invention.

FIG. 10 is similar to FIG. 6 but showing the rotating member rotated, the driven member moved rightwards.

FIG. 11 is similar to FIG. 7, but showing the rotating member rotated, the driven member moved rightwards.

FIG. 12 is similar to FIG. 6 but showing the rotating member rotated, the driven member moved leftwards.

FIG. 13 is similar to FIG. 7, but showing the rotating member rotated, the driven member moved leftwards.

FIG. 14 is an exploded view of another preferred embodiment of the present invention.

FIG. 15 is a top view in section of a part of the embodiment shown in FIG. 14.

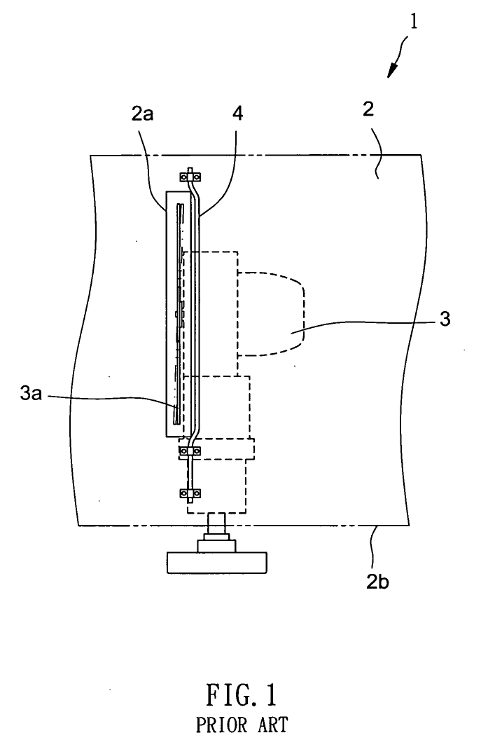

### DETAILED DESCRIPTION OF THE INVENTION

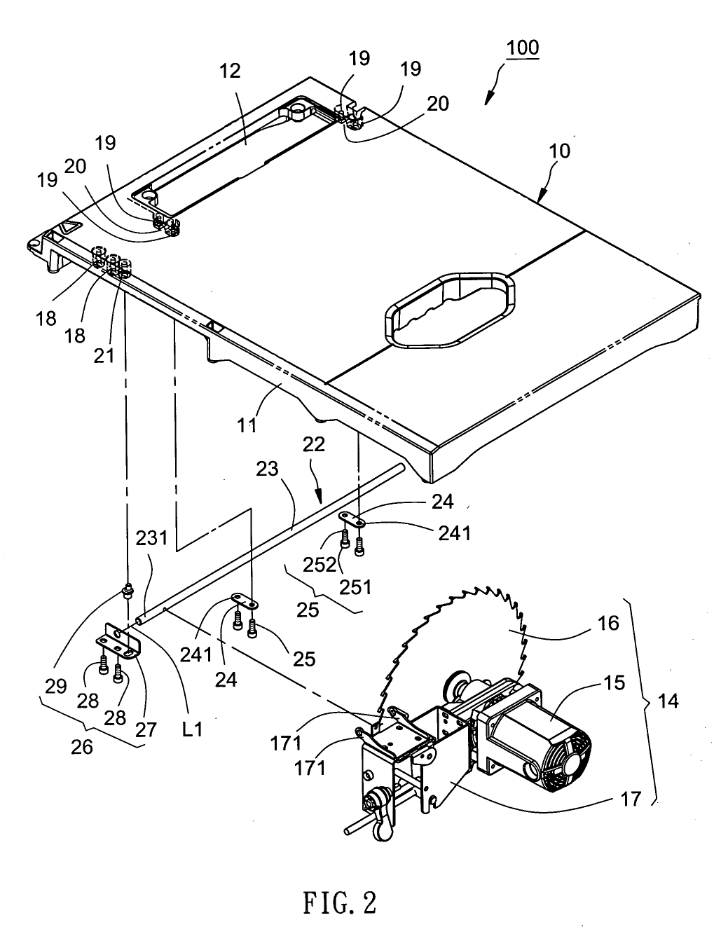

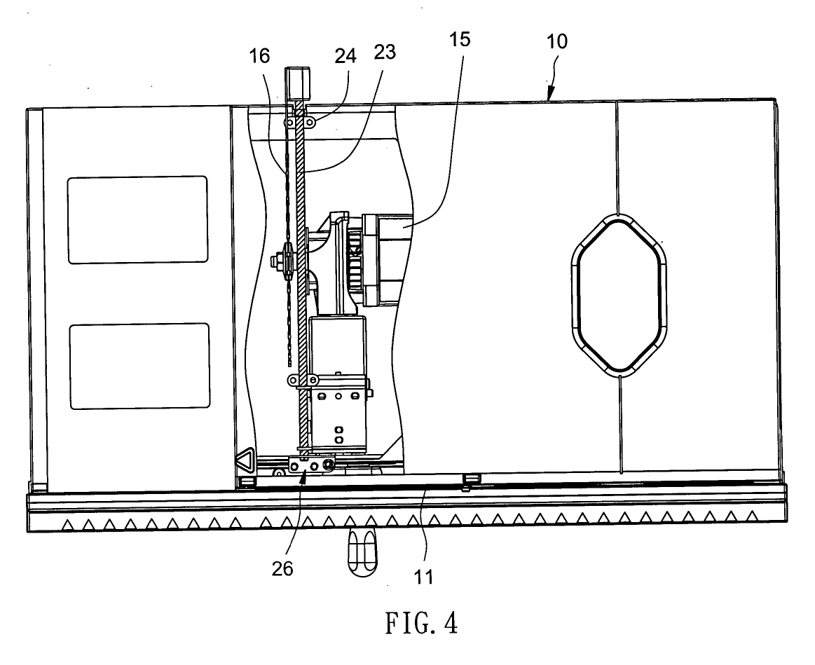

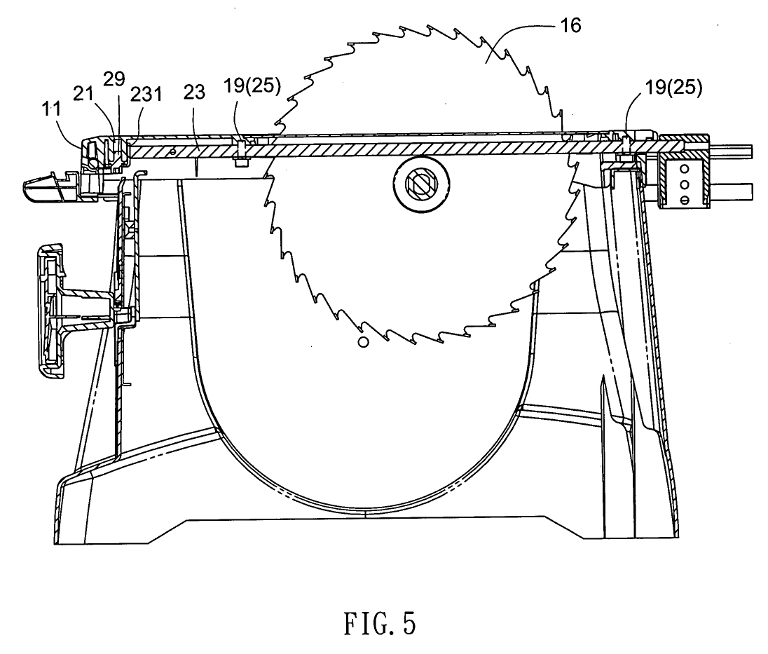

Referring to FIGS. 2-5, a saw blade adjustment structure is shown used in a table saw 100. The table saw 100 comprises a table 10 and saw unit 14. The table 10 is has a front edge 11, and an elongated opening 12. The saw unit 14 is installed in the bottom side of the table 10 adjacent to the elongated opening 12, comprising a motor 15, a circular saw blade 16, and a linking mechanism 17. The motor 15 is adapted to rotate the circular saw blade 16. The linking mechanism 17 is adapted to move the circular saw blade 16 vertically upwards and downwards and to tilt the circular saw blade 16. When the circular saw blade 16 is lifted and protruding over the top surface of the table 10, it is in the working position for cutting the workpiece. Because the saw unit 14 is of the known design, no further detailed description in this regards is necessary.

The saw blade adjustment structure of the present invention is adapted to correct the deviated saw blade to the accurate position, comprising a first connection means, which is comprised of two screw holes 18 provided at the bottom side of the table 10 near the front edge 11 of the table 10, two second connection means formed in the bottom side of the table 10 and symmetrically disposed near the two distal ends of the elongated opening 12 and each comprised of two screw holes 19 and a recess 20 between the screw holes 19, and a circular locating hole 21 formed in the bottom side of the table 10 near the screw holes 18 of the first connection means, a supporting structure 22, and an adjustment unit 26.

The supporting structure 22 comprises a supporting member 23, two locating plates 24, and four fastening members 25. The supporting member 23 is round rod extending along a first axis L1 and a connection portion 231 at one end (the action end). The two locating plates 24 each have two through holes 241. The fastening members 25 are screw members each having a head 251 and a threaded shank 252. The threaded shanks 252 of the fastening members 25 are respectively inserted through the through holes 241 of the locating plates 24 and respectively threaded into the screw holes 19, and the heads 251 of the fastening members 25 are respectively stopped at the locating plates 24 against the bottom side of the table 10 to affix the locating plates 24 to the bottom side of the table 10 over the respective recesses 20, keeping the supporting member 23 in the recesses 20.

The adjustment unit 26 is set in the bottom side of the table 10 adjacent to the front edge 11 of the table 10, comprised of a driven member 27, two locating members 28, and a rotating member 29.

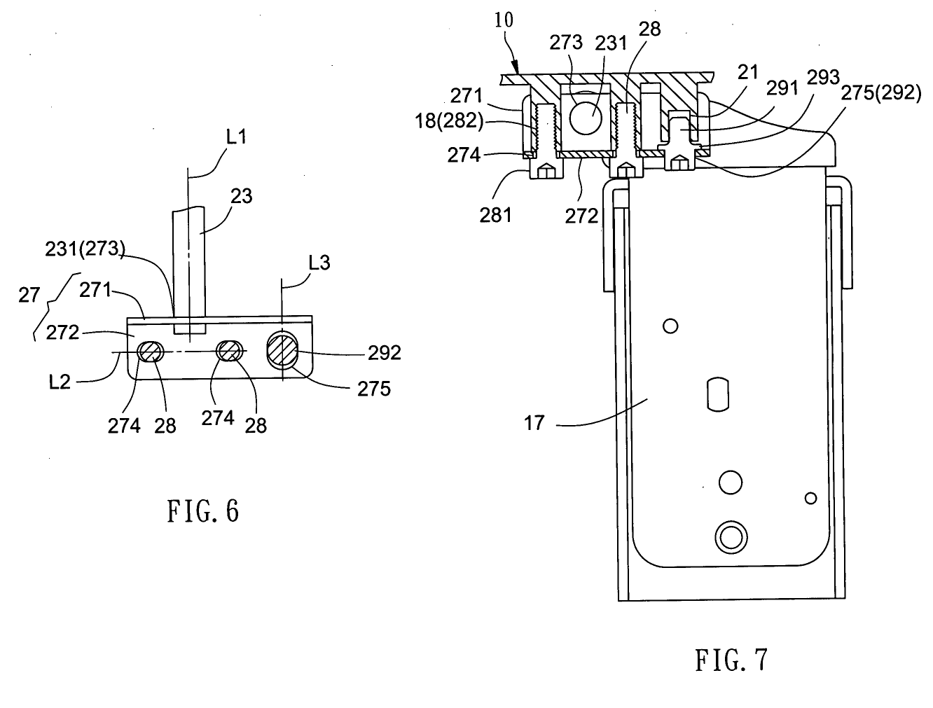

Referring to FIGS. 6 and 7, the driven member 27 has a vertical wall 271 and a horizontal wall 272 arranged at right angles, a circular hole 273 formed in the vertical wall 271 for receiving the connection portion 231 of the supporting member 23, two first oblong holes 274 formed in the horizontal wall 272 and aligned in line along a second axis L2, and one second oblong hole 2775 formed in the horizontal wall 272 and extending along a third axis L3. The aforesaid first axis L1 is parallel to the circular saw blade 16. The second axis L2 and the third axis L3 are perpendicularly intersected with each other.

The two locating members 28 are screw members each having a head 281 and a threaded shank 282. The threaded shanks 282 of the locating members 28 are respectively inserted through the first oblong holes 274 of the driven member 27 and threaded into the screw holes 18 at the bottom side of the table 10, and the heads 281 of the locating members 28 are respectively stopped at the horizontal wall 272 of the driven member 27 to secure the driven member 27 to the bottom side of the table 10, allowing the driven member 27 to be moved along the second axis L2 within the constraint of the first oblong holes 274.

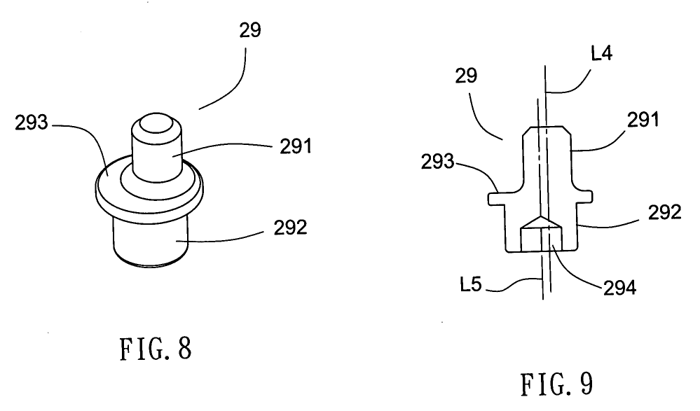

Referring to FIGS. 8 and 9, the rotating member 29 comprises a first round rod 291, a second round rod 292, a collar 293 extending around the connection portion between the first round rod 291 and the second round rod 292, and a receiving portion, for example, a hexagonal countersunk hole 294 formed in one end of the second round rod 292 remote from the first round rod 291 and axially extending inwards from the end of the second round rod 292 for receiving a driving tool, for example, a hexagonal wrench to be operated to rotate the rotating member 29. According to this embodiment, the longitudinal center axis L4 of the first round rod 291 and the longitudinal center axis L5 of the second round rod 292 are arranged in parallel, and the longitudinal center axis L5 of the second round rod 292 is deviated from the longitudinal center axis L4 of the first round rod 291, therefore the first round rod 291 and the second round rod 292 are in an eccentric relationship. During installation, as shown in FIG. 7, the first round rod 291 is inserted into the locating hole 21 at the table 10, the second round rod 292 is inserted into the second oblong hole 275 of the driven member 27, and the collar 293 is disposed in contact with the horizontal wall 272 of the driven member 27.

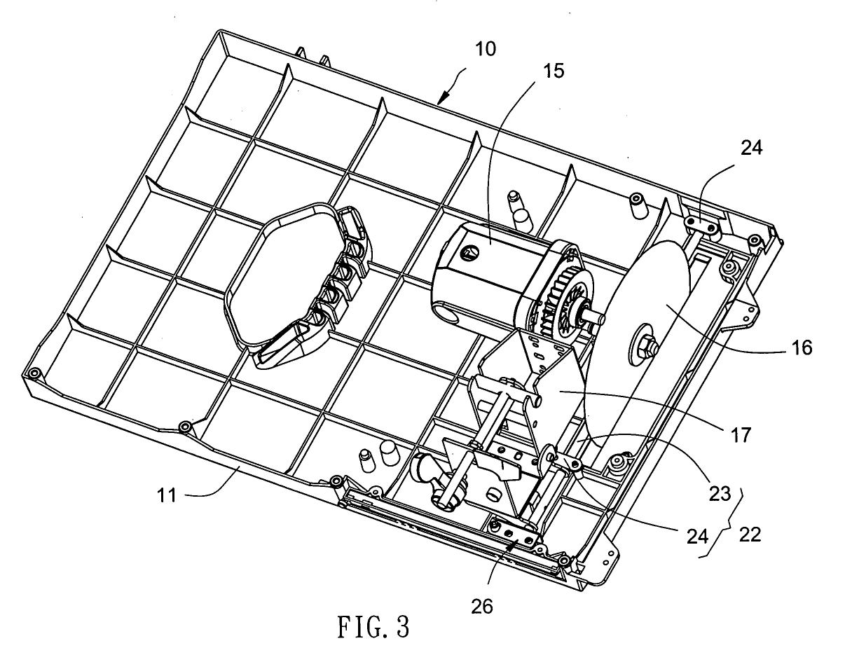

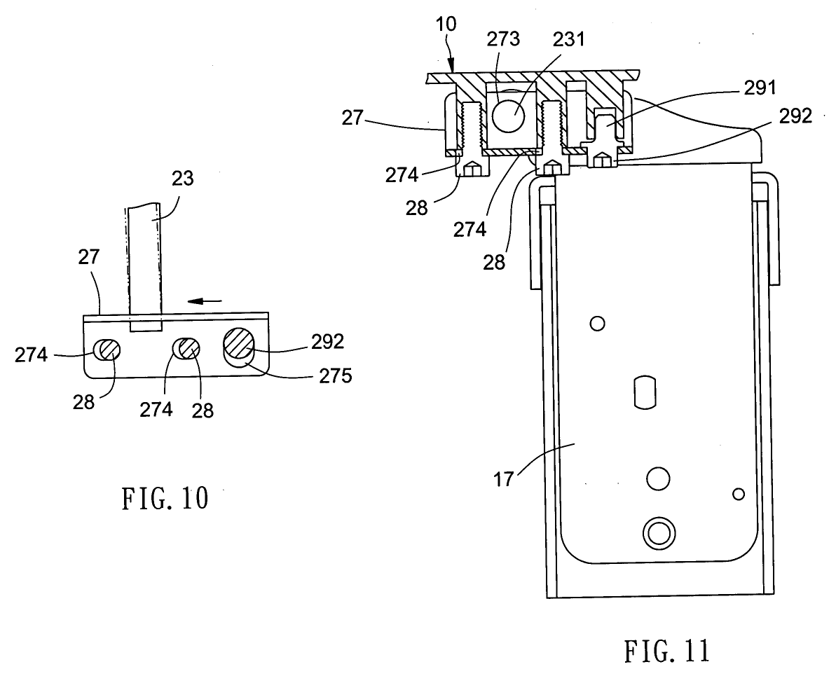

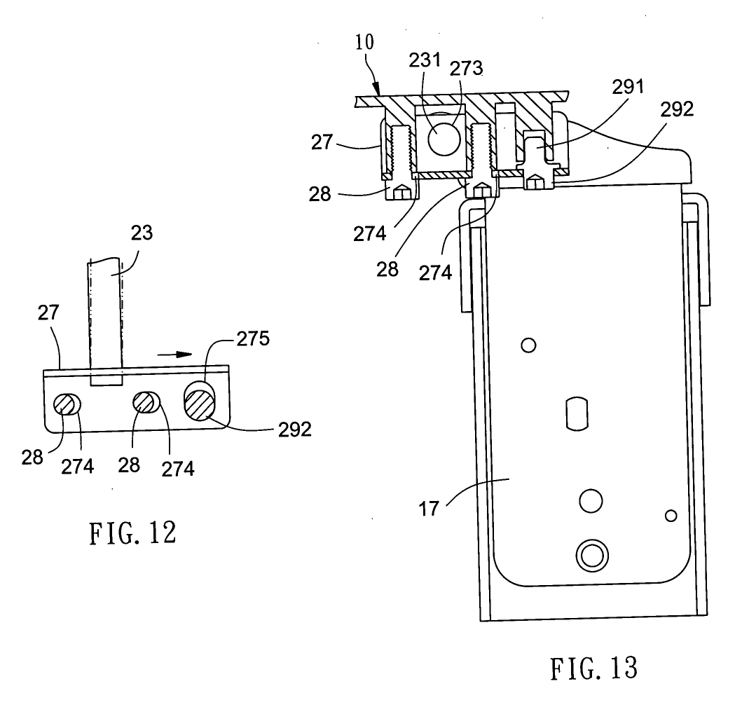

Referring to FIGS. 2 and 3 again, the saw unit 14 is fastened to the supporting member 23 through two lugs 171 of the linking mechanism 17, and disposed near the adjustment unit 26. If the circular saw blade 16 is deviated from the correct position by external factors, the operator can use a hand tool, for example, a hexagonal wrench to rotate the rotating member 29 clockwise/counter-clockwise. When rotating the rotating member 29, the second round rod 292 will be forced to move the driven member 27 rightwards (see FIGS. 10 and 11) or leftwards (see FIGS. 12 and 13). During rightward or leftward displacement of the driven member 27, the supporting member 23 and the saw unit 14 are moved synchronously, thereby correcting the position of the saw blade 16 for accurate cutting. By means of the saw blade adjustment structure, the operator can correct the position of the saw blade 16 conveniently.

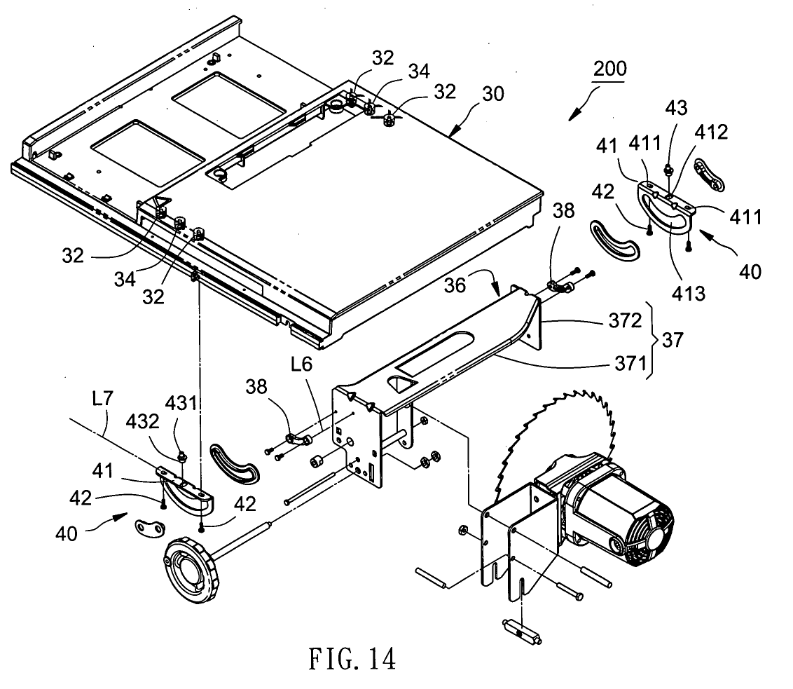

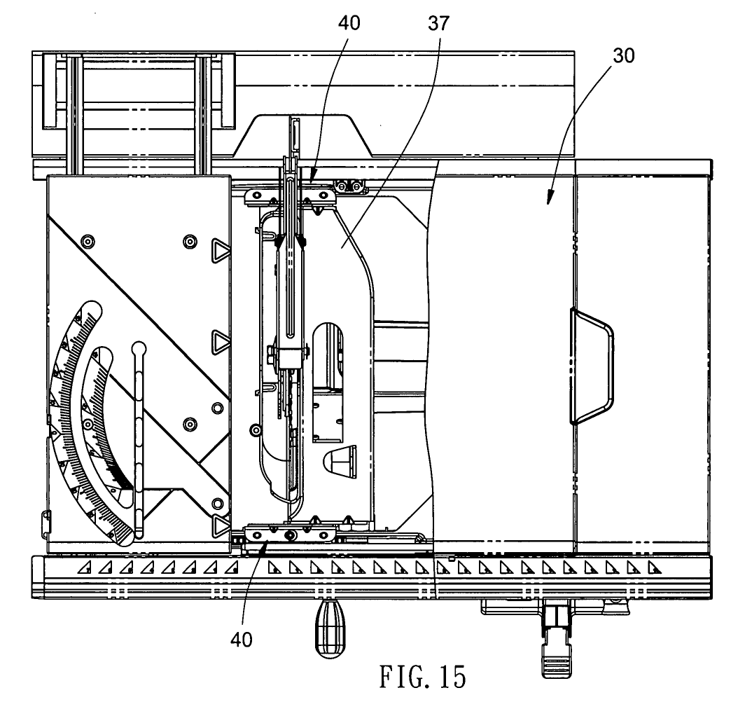

FIGS. 14 and 15 show an alternate form of the present invention. According to this embodiment, the saw blade adjustment structure comprises two first connection means each comprised of two screw holes 32 and respectively formed in the bottom side of the table 30 of the table saw 200, two circular locating holes 34 respectively formed in the bottom side of the table 30 of the table saw 200 and spaced between the two screw holes 32 of each of the two connection means, a supporting structure 36, and two adjustment devices 40.

The supporting structure 36 according to this second embodiment is comprised of one supporting member 37 and two guide members 38. The supporting member 37 has a flat base 371 and two sidewalls 372 perpendicularly downwardly extending from the two distal ends of the flat base 371. The two guide members 38 are arched blocks respectively affixed to the sidewalls 372 of the supporting member 37 at an outer side. Further, the arched track of the two guide members 38 extends across a first axis L6.

The two adjustment devices 40 each comprise a driven member 41, two locating members 42, and a rotating member 43. The driven member 41 comprises two first oblong holes 411, a second oblong hole 412, and an arched guide slot 413. The arched guide slot 413 of the driven member 41 of each of the two adjustment devices 40 are respectively coupled to the guide members 38 of the supporting structure 36, for enabling the supporting member 37 to be turned about the first axis L6. The two locating members 42 are screw members respectively inserted through the first oblong holes 411 of the respective driven member 41 and the corresponding two screw holes 32 at the table 30 to secure the respective driven member 41 to the table 30, allowing the respective driven member 41 to be moved along the second axis L7 within the constraint of the first oblong holes 411. The rotating member 43 comprises a first round rod 431 and a second round rod 432 arranged in an eccentric relationship. The first round rod 431 is inserted into one locating hole 34. The second round rod 432 is inserted into the second oblong hole 412 of the respective driven member 41 and extending in direction perpendicular to the first oblong holes 411. By means of rotating the rotating member 43, the respective driven member 41 is moved to correct the position of the saw blade.

Further, because the table saw 200 comprises two adjustment devices 40, the user can selectively operate one of the adjustment devices 40 to correct the position of the saw blade.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A saw blade adjustment structure used in a table saw having a table having a bottom side, an elongated opening formed in said table, and a saw unit installed in the bottom side of said table, said saw unit having a saw blade suspending in said elongated opening for cutting, the saw blade adjustment structure comprising:
a supporting structure having a supporting member provided below the bottom side of said table and connected to said saw unit, said supporting member having at least one connection portion and defining a first axis; and
at least one adjustment device set between said table and said supporting structure, said at least one adjustment device each comprising a driven member coupled to one of the at least one connection portion of said supporting member and movable along a second axis that is not in parallel to said first axis, and a rotating member having an eccentric portion for moving said driven member along the second axis upon rotation of said rotating member.

2. The saw blade adjustment structure as claimed in claim 1, wherein said driven member comprises at least one first oblong hole defining said second axis; said at least one adjustment device each comprises at least one locating member respectively inserted through the at least one first oblong hole of said driven member and fastened to the bottom side of said table to secure said driven member to said table.

3. The saw blade adjustment structure as claimed in claim 2, wherein said table of said table saw comprises a locating hole at the bottom side thereof; said driven member comprises a second oblong hole defining a third axis that is not parallel to said second axis; said rotating member comprises a first round rod coupled to said locating hole of said table and a second round rod axially extending from one end of said first round rod in an eccentric relationship to form said eccentric portion, said second round rod being coupled to said second oblong hole of said driven member.

4. The saw blade adjustment structure as claimed in claim 3, wherein said supporting member of said support means is a round rod having one end terminating in one of said at least one connection portion; said supporting structure further comprises at least one locating member fixedly fastened to the bottom side of said table to support said supporting member; said driven member comprises a through hole for the passing of the connection portion of said supporting member.

5. The saw blade adjustment structure as claimed in claim 3, wherein said supporting member of said supporting structure comprises a flat base and two sidewalls at two distal ends of said flat base; said supporting structure comprises two guide members respectively coupled to the sidewalls of said supporting member on said first axis; the driven member of each of said at least one adjustment device comprises a guide slot for receiving said guide members for enabling said supporting member to be turned about said first axis.

6. The saw blade adjustment structure as claimed in claim 3, wherein said second round rod has a receiving portion for receiving an external rotary driving force to rotate said rotating member.

7. The saw table adjustment structure as claimed in claim 3, wherein said first axis extends in parallel to said saw blade; said second axis is perpendicularly intersected with said first axis; said third axis is perpendicularly intersected with said second axis.

8. A saw blade adjustment structure used in a table saw having a table having a bottom side, an elongated opening formed in said table, and a saw unit installed in the bottom side of said table, said saw unit having a saw blade suspending in said elongated opening for cutting, the saw blade adjustment structure comprising:
a supporting member provided below the bottom side of said table and connected to said saw unit, said supporting member having an action end and defining a first axis in parallel to the cutting direction of said saw blade; and
at least one adjustment device set between said table and said supporting member for moving said supporting member along a second axis that is not in parallel to said first axis.

9. The saw blade adjustment structure as claimed in claim 8, wherein said at least one adjustment device each comprises a driven member coupled to the action end of said supporting member and having at least one oblong hole, at least one locating member respectively inserted through the at least one oblong hole of said driven member and fastened to said table of said table saw to secure said driven member to said table and for enabling said driven member to be moved along said second axis, and a rotating member having an eccentric portion for moving said driven member along the second axis upon rotation of said rotating member.

10. The saw blade adjustment structure as claimed in claim 9, wherein said table of said table saw comprises a locating hole at the bottom side thereof; said driven member comprises a second oblong hole defining a third axis that is not parallel to said second axis; said rotating member comprises a first round rod coupled to said locating hole of said table and a second round rod axially extending from one end of said first round rod in an eccentric relationship to form said eccentric portion, said second round rod being coupled to said second oblong hole of said driven member.
